(19) United States
(12) Patent Application Publication
(10) Pub. No.: US 2019/0256359 A1
(43) Pub. Date: Aug. 22, 2019

(54) METHOD FOR THE PREPARATION OF A SOLID CARBONACEOUS MATERIAL LOCALLY CONTAINING GRAPHITE

(71) Applicant: Centre National de la Recherche Scientifique, Paris (FR)

(72) Inventors: Louis Hennet, Sandillon (FR); Mohamed-Ramzy Ammar, Fleury les Aubrais (FR); Encarnacion Raymundo-Pinero, Saint-Cyr-En-Val (FR); Michael Deschamps, Orleans (FR); Biao Zhang, Paris (FR); Jean-Marie Tarascon, Mennecy (FR)

(21) Appl. No.: 16/317,543

(22) PCT Filed: Jul. 12, 2017
(86) PCT No.: PCT/FR2017/051921

§ 371 Date: Jan. 12, 2019

(30) Foreign Application Priority Data
Jul. 13, 2016 (FR) 16 56752

(51) Int. Cl. C01B 32/205

(52) U.S. Cl. CPC C01B 32/205; C01P 2006/40; C01B 2204/22

(57) ABSTRACT

The invention relates to a method for the preparation of a solid carbonaceous material locally graphitized from a self-supporting hard carbon using laser isolation.

### CROSS-REFERENCE TO RELATED APPLICATIONS

This application claims benefit under 35 USC § 371 of PCT Application No. PCT/FR2017/051921 entitled DEVICE FOR GENERATING A RANDOM SIGNAL AND ASSOCIATED ARCHITECTURE, filed on Jul. 12, 2017 by inventors Louis Hennet, Mohamed-Ramzi Ammar, Encarnacion Raymundo-Pinero, Michaël Deschamps, Biao Zhang and Jean-Marie Tarascon. PCT Application No. PCT/FR2017/051921 claims priority of French Patent Application No. 16 56752, filed on Jul. 13 2016.

### FIELD OF THE INVENTION

The invention relates to a method for the preparation of a solid carbonaceous material locally containing graphite from a self-supporting hard carbon using laser isolation.

### BACKGROUND OF THE INVENTION

The carbon can form bonds with different sp¹, sp², sp³ hybridizations and can thus exist under a very large variety of crystalline or disordered structures. The properties of the carbonaceous materials depend on the type of bonds between the carbon atoms, the level of hydrogen atoms bonded to the carbon atoms, and their crystalline, amorphous or disordered structure.

Lithium-ion batteries are known, which use a carbonaceous material at the negative electrode. The carbonaceous material may be a disordered carbon such as a “hard carbon” or a “soft carbon” in which sp² and sp³ carbons coexist, or a natural or artificial graphite (i.e. having 100% sp² carbon), possibly covered with non-graphitized carbon. The hexagonal structure graphite consists of hexagonal plane sheets of sp² carbons, called graphenes. In each sheet, each carbon atom is bound by sigma-type bonds for its 3 sp² electrons and n-type bonds for its other p electron. These π-type bonds are conjugated with the three neighboring atoms. The tridimensional structure of the graphite thus corresponds to an ordered stack of graphene layers. In contrast, hard and soft carbons are characterized by a disordered structure. Soft carbons (also called graphitizable carbons, i.e., they can be converted to hexagonal graphite when heated to temperatures above about 2400° C.) have more or less parallel-oriented layers, whereas hard carbons (also called non-graphitizable carbons) are characterized by total disorientation of the layers. Hard carbons are generally quite rich in heteroatoms (oxygen, sulfur, etc.) which act as crosslinking agents, and prevent paralleling of the sheets during a subsequent heat treatment at high temperature. The heat treatment mentioned above generates a locally graphitized material having a two-dimensional structural order. In comparison with hard carbon, graphite is often preferred in lithium-ion batteries because it allows better power performance and irreversible capacity (mainly consumed during the first cycle in the formation of the passivation layer), also well known as “SEI” for Solid Electrolyte Interphase), and is lower, inducing a higher energy density. However, graphite has low sodium insertion properties, in particular because sodium has an ionic radius about 55% greater than that of lithium, making its intercalation difficult in some anode materials such as graphite. In addition, the future of lithium-ion batteries could be compromised, both because lithium resources are limited and because the cost of lithium-based raw materials has almost doubled since their first use in 1991 up to the present day, and has further increased due to the increasing global demand for lithium-ion accumulators.

Thus, recent research has focused on the design of negative electrodes based on carbonaceous materials other than graphite for sodium-ion batteries. In fact, sodium-ion batteries could be an alternative solution of choice and replace lithium batteries, thanks to the greater availability of sodium precursors in nature (earth crust, sea water, etc.) and their low cost.

Moreover, hard carbon has the advantage of delivering a large capacity (i.e. of the order of 250 mAh/g) thanks to the random orientation of small layers of graphene that provides a porosity (e.g. surface nanopores) that favors the insertion of sodium ions. The methods for preparing a hard carbon generally comprise at least one step of pyrolysis of a carbon precursor such as an organic material (e.g. glucose, lignin, cellulose) or a thermoplastic resin (e.g. polyacrylonitrile, phenol-formaldehyde, polypyrrole) at a temperature of at least 1000° C. A hard carbon is thus obtained comprising randomly-oriented graphene layers, and possibly graphitic nano-domains. For example, Zhang et al. [Advanced Energy Materials, 2016, 6,1, 1501588, 1-9] described the preparation of a hard carbon type carbonaceous material by heating a film of polyacrylonitrile fibers under air at 250° C. for 3 hours in order to form an intermediate material, in particular by cyclization, dehydrogenation and/or oxidation reactions; and by argon heat treatment of the intermediate material for 20 minutes to 1 hour at a temperature between 650 and 2800° C. Generally, the galvanostatic cycling curve in a sodium-ion battery of the carbonaceous material obtained after carbonization shows two regions: a first region consisting of a slope between 0.1 and 1.0 V and a second region consisting of a plateau at about 0.1 V, which gives a cumulative capacity of 200 to 300 mAh/g. The contribution of the two above-mentioned regions to the overall capacity depends mainly on the structure of the carbonaceous material. In particular, it has been shown that a high heat treatment temperature (e.g. greater than about 2000° C.) makes it possible to increase the degree of graphitization of the carbonaceous material obtained, and thus the capacity associated with the second region (plateau), while the capacity associated with the first region diminishes. Such carbonaceous materials having a large proportion of the total capacity in the second region, can increase the output voltage of the electrochemical cell and thus improve the electrochemical performance of a sodium-ion battery. In addition, a high thermal treatment temperature also allows the formation of a nanoporous network leading to the improvement of the insertion of sodium, and thus to a higher capacity in the second region.

The heat treatment at a temperature, for example, greater than or equal to 1800-2000° C. has the disadvantage of being long and energy consuming since it requires the use of special furnaces to produce such temperatures. Most materials constituting conventional furnaces (e.g. ceramics such as aluminum tubes) begin to melt at such temperatures.

The use of graphitization catalysts to graphite hard carbon at lower temperatures has been proposed.

In parallel, laser systems are known to be used on carbonaceous materials for their structural characterization (e.g. Raman spectroscopy) or for their preparation (reduction of graphene oxide to graphene through laser irradiation). They are also known to locally graphite a thin layer of amorphous carbon (e.g. a layer thickness of about 22 to about 104 nm), wherein the layer is previously deposited on a silicon substrate through filtered cathode arc deposition. For example, Roch et al. [Thin Solid Films, 2011, 519, 3756-3761] described pulse laser irradiation at 355 nm (i.e. in the ultraviolet range) of such a thin film of supported carbon. However, the operating conditions are not optimized to allow homogeneous graphitization of a solid hard carbon with a high degree of graphitization. In fact, delamination of the carbonaceous deposit is observed during the laser irradiation, in particular when the power of the laser is too high and/or the thin carbon layer reaches a certain thickness (e.g. >20 nm). In particular, the laser energy absorbed by the amorphous carbon layer is transferred by thermal diffusion to the silicon substrate which begins to melt and induces the delamination of the carbon layer or certain zones of the layer. Graphitization is therefore limited by the presence of the substrate. Moreover, when the delamination is avoided, the presence of the substrate does not allow direct use of the thin graphitized amorphous carbon film so obtained, as a negative electrode in a sodium-ion battery (e.g. an additional substrate separation step may prove to be complex).

### BRIEF DESCRIPTION OF THE DRAWINGS

Other features and advantages of the invention will appear upon reading the description which follows, given solely by way of example and with reference to the appended drawings, wherein:

FIG. 1 shows the laser system used in the examples, in accordance with an embodiment of the present invention;

FIG. 2 shows a transmission electron microscopic (TEM) image of the non-conforming carbon fibers, in accordance with an embodiment of the present invention;

FIG. 3 shows (a) a Raman spectrum of the carbon fibers obtained, in accordance with an embodiment of the present invention, and (b) a Raman spectrum of the carbonaceous material obtained, in accordance with an embodiment of the present invention;

FIG. 4 shows a galvanostatic charge-discharge curve during the first two cycles of the carbon fibers, in accordance with an embodiment of the present invention;

FIG. 5 shows a galvanostatic charge-discharge curve during the first two cycles of the carbonaceous material (voltage in volts as a function of the capacity in mAh/g), in accordance with an embodiment of the present invention;

FIG. 6 shows a good resistance to cycling of the carbonaceous material obtained, in accordance with an embodiment of the present invention;

FIG. 7 shows a galvanostatic charge-discharge curve during the first two cycles of the carbon fibers, in accordance with an embodiment of the present invention; and

FIG. 8 shows a galvanostatic charge-discharge curve during the first two cycles of the carbonaceous material (voltage in volts according to the capacity in mAh/g), in accordance with an embodiment of the present invention.

### DETAILED DESCRIPTION

The object of the present invention is to overcome the drawbacks of the prior art and to propose a simple and economical method for preparing a self-supporting solid carbon material which may be used directly as a negative electrode in a sodium-ion battery, while guaranteeing good electrochemical performance, especially in terms of cell output voltage and capacitance.

The invention firstly relates to a method for the preparation of a solid carbonaceous material locally graphitized, characterized in that it comprises at least one step i) of laser irradiation of a self-supporting solid hard carbon comprising at least two surfaces S₁ and S₂ spaced apart from each other by a distance d, with the proviso that:
the self-supporting solid hard carbon comprises at least about 80 mol % of carbon and at most about 20 mol % of one or more elements selected from among hydrogen and heteroatoms,
step i) is carried out by simultaneously irradiating the surfaces S₁ and S₂ of the self-supporting solid hard carbon,
a first laser beam F₁ irradiates the surface S₁ in a direction D₁, while a second laser beam F₂ irradiates the surface S₂ in a direction D₂ opposite to the direction D₁,
the directions D₁ and D₂ of the beams F₁ and F₂ are substantially aligned, and
each of the laser beams F₁ and F₂ operates at a wavelength ranging from about 0.8 μm to about 15 μm, preferably at a wavelength ranging from about 8 μm to about 14 μm, and more preferably at a wavelength ranging from about 10 μm to 11 μm, and provides a power density that is sufficient to graphite locally self-supporting solid hard carbon.

The method of the invention is simple and economical. In particular, it implements a step i) that is faster and consumes less energy compared to conventional methods, thus avoiding the time and energy losses induced by the rise and fall in temperature and/or the use of special ovens. Moreover, it makes it possible to form a self-supporting solid carbonaceous material offering good electrochemical performance, in particular thanks to its good local structural organization. In fact, step i) makes it possible to promote or improve the local structural order of a self-supporting solid hard carbon. Finally, the method of the invention makes it possible to form a homogeneous material at the micrometric scale, i.e. in which the graphitation is uniformly distributed.

In the present invention, the term “hard carbon” means a carbon comprising randomly-oriented graphene layers and amorphous domains. The hard carbon used in step i) thus has a disordered structure.

The disordered character of the hard carbon used in step i) may also be evaluated by Raman spectroscopy. First-order Raman spectra of graphitic carbons show two main bands. The first band (band G), centered at 1580 cm⁻¹, corresponds to the vibration code E_{2g} of the graphite (vibration of the carbon atoms in the basal plane). The second band (band D), observed around 1350 cm⁻¹ (for a laser excitation of 514.5 nm) is absent in the case of graphite and present in a disordered carbon. The band D, which corresponds to the breathing mode of the aromatic cycle, is thus attributed to the presence of disorder.

In the present invention, the self-supporting solid hard carbon preferably has a ratio of the intensities of the D and G bands: I_{D}/I_{G} greater than or equal to 0.5; and more preferably greater than or equal to 1.

A band G′ (2D) at approximately 2700 cm⁻¹ corresponding to the mode of breathing of the polyaromatic layers (second order of the D defect band) may be observed when a carbonaceous material has a certain degree of structural organization. The self-supporting solid hard carbon of step i) does not generally have a G′ band.

In the present invention, the self-supporting solid hard carbon preferably has a ratio of the intensities of the G′ and G bands: ID/IG less than 0.2.

In the present invention, the term “solid” means that the carbon is not in the form of a powder (i.e. in powder form).

In the present invention, the term “self-supporting hard carbon” means that the hard carbon does not comprise a substrate or support. In other words, it is used “as is” in step i) and is not in the form of a layer of the hard carbon previously deposited on a substrate or a support by chemical and/or physical reaction.

In the present invention, the term “heteroatom” means an atom of an organic molecule having at least one electron pair, but which is not a carbon atom, a hydrogen atom, or an atom of a metal element.

In the present invention, the term “irradiation with a laser beam” also means laser irradiation.

In the present invention, the expression “substantially aligned” means that the directions D₁ and D₂ are on the same axis (i.e. directions D₁ and D₂ together) or on two distinct axes forming an angle less than or equal to about 3°, and of preferably less than or equal to about 2°, and preferably less than or equal to about 1°.

The heteroatoms generally present in the hard carbon are oxygen, nitrogen and/or sulfur, and preferably oxygen and/or nitrogen.

According to a preferred embodiment of the invention, the self-supporting solid hard carbon used in step i) comprises at least about 90 mol % carbon and at most about 10 mol % of one or more selected elements chosen from among hydrogen and heteroatoms.

In particular, the self-supporting solid hard carbon used in step i) comprises at least about 95 mol % carbon and at most about 5 mol % of one or more elements selected from among hydrogen and heteroatoms.

The self-supporting solid hard carbon used in step i) preferably comprises at most about 1 mol % of hydrogen.

The self-supporting solid hard carbon used in step i) generally comprises Sₚ₂ and Sₚ₃ carbons.

The proportion of Sₚ₂ carbons is preferably at least about 50%, and preferably at least about 80%, based on the sum of the sp² and sp³ carbons.

The proportion of carbons sp²is preferably at most about 90%, based on the sum of the sp² and sp³ carbons.

Step i) preferably lasts from about 1 second to 1 hour, more preferably from 10 seconds to about 30 minutes, and more preferably from 10 seconds to about 10 minutes.

Preferably, each of the laser beams has a diameter ranging from about 5 to 10 mm.

Each of the laser beams preferably has a substantially constant diameter (i.e. unfocused laser beams).

In particular, each of the beams is a Gaussian beam.

The diameters of the laser beams are preferably identical.

Step i) is preferably carried out under vacuum, especially at a pressure of less than about 10⁻⁴ mbar or at atmospheric pressure under a stream of ultra pure neutral gas comprising an amount of oxygen <0.1 ppm (e.g. argon).

Step i) may be carried out several times, in particular in order to simultaneously irradiate several times the surfaces S₁ and S₂ of the self-supporting solid hard carbon that have already been irradiated a first time.

The reiteration of step i) may be carried out with a power density that is identical to or greater than that of the preceding step i).

When step i) is performed several times, the power of the laser beam may be gradually increased after each irradiation.

The power density of the two laser beams is preferably identical. This makes it possible to uniformly irradiate the two surfaces S₁ and S₂ of the self-supporting solid hard carbon and to avoid the formation of thermal gradients within the carbonaceous material during the irradiation.

Step i) may be performed by moving the self-supporting solid hard carbon along an axis that is substantially perpendicular to the directions D₁ and D₂ of the laser beams F₁ and F₂, preferably at a so-called “displacement” speed ranging from 0.01 to 10 mm.s⁻¹ approx. This allows the entire surface S₁ and the entire surface S₂ to be irradiated.

The term “substantially perpendicular” means that the self-supporting solid hard carbon moves along an axis having an angle ranging from about 80° to about 100°, and preferably ranging from about 85° to about 95°, with respect to the directions D₁ and D₂ of the F₁ and F₂ beams.

In another embodiment, step i) is performed by moving the two laser beams (i.e. the impact zones of the lasers) relative to the self-supporting solid hard carbon. However, this embodiment is more complex to implement in order to maintain the alignment of the directions D₁ and D₂ of the respective beams F₁ and F₂ and a homogeneous power density.

The laser beam F₁ preferably has an impact zone P₁ which coincides with the surface S₁ to be irradiated.

The laser beam F₂ preferably has an impact zone P₂ which coincides with the surface S₂ to be irradiated.

The irradiation during step i) is performed at the impact zone P₁ of the surface S₁ and the impact zone P₂ of the surface S₂, wherein the power is sufficient for it to be extended at the level of the impact zones in the space between the surfaces S₁ and S₂ (solid carbon core). As the directions D₁ and D₂ of the beams F₁ and F₂ are aligned and in the opposite direction, the impact zones P₁ and P₂ are opposite one another and spaced apart by a distance d as defined in the invention. This thus makes it possible to graphite the solid hard carbon in a homogeneous manner since the formation of significant heating (induced by irradiation) at the core of the self-supporting solid hard carbon is avoided.

When the directions D₁ and D₂ of the beams F₁ and F₂ are not aligned, the material obtained at the end of step i) is easily broken or crumbled due to the formation of the aforementioned gradients.

Step i) is preferably carried out using a laser system comprising at least one laser, a chamber at vacuum or at atmospheric pressure under a stream of ultra pure neutral gas comprising an amount of oxygen <0.1 ppm, wherein the chamber comprises a sample holder that is designed to receive the self-supporting solid hard carbon, and optical means that are configured to direct the beam F₁ in the direction D₁, and the beam F₂ in the direction D₂.

The optical means may be windows, and possibly mirrors.

The windows may be any material that is transparent to the wavelength of the laser used, such as zinc selenide, germanium selenide, sodium chloride or potassium chloride.

The mirrors may be metal or metalloid, in particular of silicium or copper covered with a perfectly reflective metal layer such as a layer of gold.

The mirrors (planar or conical) allow irradiation by reflection of the surfaces S₁ and S₂ (i.e. indirect irradiation).

Thus, when the laser beam F₁ (respectively the laser beam F₂) has an initial direction D_{1′}, (respectively D_{2′}), the mirror serves to modify the orientation of the laser beam F₁ (respectively the laser beam F₂) according to the desired direction D₁ (respectively D₂) as defined in the invention.

The laser may be a carbon dioxide laser or a solid laser based on neodymium ion or ytterbium emitting in the infrared.

Among examples of solid lasers based on neodymium or ytterbium ion emitting in the infrared may be mentioned Nd: YAG lasers (neodymium-doped yttrium aluminum garnet Nd: Y₃Al₅O₁₂), Yb: YAG (Yb: Y₃Al₅O₁₂), Nd: YVO₄ or Nd: YLF (Nd: YLiF₄).

The carbon dioxide laser is preferred.

The laser power density may vary from about 10 to 4000 W/cm², and preferably from about 50 to 150 W/cm².

The laser may be a laser that operates continuously or in pulses.

The laser may be configured to directly irradiate at least one of the S₁ or S₂ surfaces of the self-supporting solid hard carbon.

According to a preferred embodiment, the laser system may comprise two lasers, in particular two carbon dioxide lasers.

In particular, the laser system may comprise:
a first carbon dioxide laser configured to deliver the first beam F₁ in an initial direction D_{1′},
a second carbon dioxide laser configured to deliver the second beam F₂ in an initial direction D_{2′},
the chamber under vacuum,
a first mirror M₁ designed to orient the first beam F₁ in the direction D₁,
a second mirror M₂ designed to orient the second beam F₂ in the direction D₂,
a first window Fe₁ located between the chamber and the mirror M₁ and designed to cause the beam F₁ to enter the room in the direction D₁ to an impact zone P₁ coinciding with the surface S₁, and
a second window Fee located between the chamber and the mirror M₂ and designed to cause the beam F₂ to enter the chamber in the direction D₂ to an impact zone P₂ coinciding with the surface S₂.

In a particular embodiment, the laser system comprises a camera to control the morphology of the self-supporting solid hard carbon.

The laser system may further comprise an infrared pyrometer for measuring the temperature of the sample in the chamber.

The mirrors preferably have a reflectivity greater than about 95%, and more preferably greater than about 99%.

The windows preferably have a transmission greater than about 95%, and more preferably greater than about 99%.

The direction D₁ of the beam F₁ (respectively the direction D₂ of the beam F₂) is preferably perpendicular to the surface S₁ (respectively to the surface S₂) of solid hard carbon or substantially perpendicular to the surface S₁ (respectively to the surface S₂).

The term “substantially perpendicular” means that the direction D₁ of the beam F₁ (respectively the direction D₂ of the beam F₂) has an angle varying from 80° to about 100°, and preferably from 85° to about 95°, with respect to the surface S₁ (respectively on the surface S₂).

The surfaces S₁ and S₂ are preferably planar, and more preferably parallel to each other.

The self-supporting solid hard carbon may be in the form of a film or a layer, wherein the film or the layer has, in particular, a thickness ranging from 20 to about 200 μm.

In this embodiment, the film or layer is delimited in the direction of its thickness by the surfaces S₁ and S₂ as defined in the invention. The thickness of the layer or film therefore corresponds to the distance d as defined in the invention.

As these embodiments are in no way limiting, it is possible to consider variants of the invention comprising only a selection of characteristics described above and that are isolated from the other characteristics described.

The method of the invention may furthermore comprise a step prior to step i) during which the self-supporting solid hard carbon is prepared from at least one non-graphitizable organic precursor, in particular chosen from the non-graphitizable organic and non-organic polymers and non-graphitizable organic compounds.

By way of example of non-graphitizable organic polymers, mention may be made of cellulose or its derivatives (e.g. cellulose esters and ethers), polypyrrole, polyvinyl alcohol, polyacrylonitrile, amide, vinyl polyacetate, phenolic resins, polyolefins (e.g. polyethylene, polypropylene) or lignin.

As an example of non-graphitizable organic compounds, mention may be made of glucose or sucrose.

The non-graphitizable organic precursor may be in the form of fibers.

Polyacrylonitrile fibers are preferred.

In particular, the self-supporting solid hard carbon is prepared according to the following substeps:

a) optionally a substep of heating at least one non-graphitizable organic precursor as defined in the invention, in air at a temperature ranging from approximately 150 to 350° C., and preferably from approximately 200 to 300° C., and

b) a substep of heating the product resulting from substep a) or from at least one non-graphitizable organic precursor as defined in the invention, under an inert atmosphere at a temperature ranging from about 800 to 1500° C., and preferably from about 1000 to about 1300° C.

The heating sub-step a) is a stabilization step. In particular, it makes it possible to avoid splitting the chains during the removal of the heteroelements during step b).

In sub-step a) the non-graphitizable organic precursor generally undergoes oxidation, cyclization and/or dehydrogenation reactions. At the end of the sub-step a), a thermally-stable intermediate material is obtained.

The presence of this sub-step is optional and depends on the nature of the non-graphitic organic precursor used.

Sub-step a) may be carried out in a conventional oven.

The heating sub-step b) is a carbonization step.

It is carried out under an inert atmosphere, i.e. in the presence of an inert gas.

The inert gas may be selected from argon, nitrogen or helium.

Sub-step b) may be carried out in a conventional oven.

The locally-graphitized carbon material obtained according to the method of the invention preferably comprises at least about 90% by weight of carbon and at most about 10% by weight of one or more elements selected from hydrogen and heteroatoms.

The heteroatoms generally present in the locally graphitized carbonaceous material are oxygen, nitrogen and/or sulfur, and preferably oxygen and/or nitrogen.

According to a preferred embodiment of the invention, the locally graphitized carbon material comprises at least about 90 mol % of carbon and at most about 10 mol % of one or more elements selected from among hydrogen and heteroatoms.

In particular, the locally graphitized carbonaceous material comprises at least about 95 mol % of carbon and at most about 5 mol % of one or more elements selected from among hydrogen and heteroatoms.

The locally graphitized carbonaceous material generally comprises sp² and sp³ carbons or only sp² carbons.

The proportion of sp² carbons is preferably at least about 95%, based on the sum of sp² and sp³ carbons.

In the present invention, the locally graphitized carbonaceous material preferably has an ID/IG ratio between 0.5 and 1.5; and more preferably about 1.

The band G′ (2D) preferably has an ID/IG ratio between 0.5 and 1.5; and preferably equal to about 1.

The locally obtained carbonaceous material is self-supporting, i.e., it is not in the form of a layer deposited (by chemical reaction and/or physical reaction) on a support or a substrate.

The locally graphitized carbonaceous material preferably comprises randomly-oriented graphene layers and nanographitic surfaces.

In the present invention, the term “nano-graphitic domains” means domains having a structure similar to that of graphite, i.e. domains in which the carbon atoms are ordered according to planar graphene layers, stacked in a parallel, equidistant and turbostratic manner, preferably compacted domains of at least 2 planar graphene layers, stacked in a parallel and equidistant manner, and more preferably domains consisting of 2 to 20 planar graphene layers, stacked in a parallel and equidistant manner.

The locally graphitized solid carbonaceous material as obtained according to the method according to the first object of the invention may be used as an active negative electrode material, in particular in a sodium-ion battery.

The material is as defined in the invention.

The presence of relatively small and randomly oriented (and therefore nanoporous lattice-like) graphene layers and of graphitic domains leads to the production of a locally graphitized carbonaceous material which has both the intercalation ability of sodium and thus good capacity; and a higher output voltage of the electrochemical cell.

### EXAMPLES

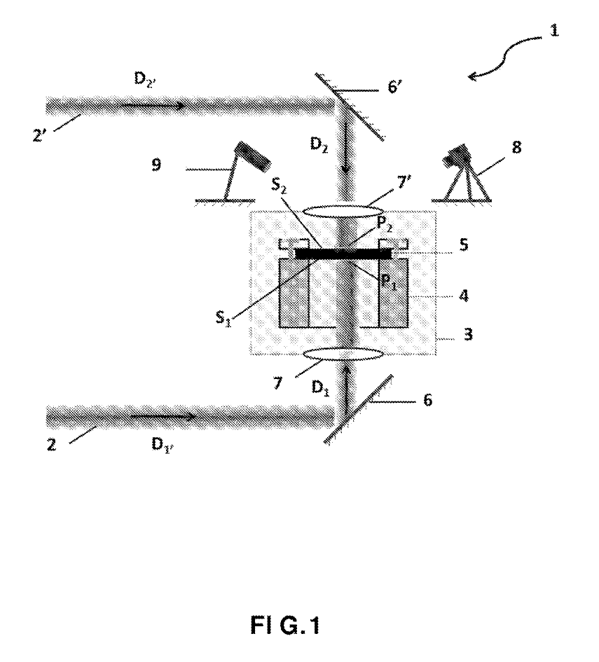

The laser system used in the examples below is shown in FIG. 1.

The laser system 1 comprises:
two carbon dioxide lasers configured to respectively deliver two Gaussian beams F₁ and F₂ (2, 2′) of constant diameter of approximately 5 mm in the respective initial directions D₁ and D_{2′},
a chamber 3 under vacuum maintained at a pressure of less than 10⁻⁵ mbar containing a sample holder 4, for example made of aluminum, and capable of receiving a sample 5 to be irradiated (e.g. self-supporting solid hard carbon as defined in the invention),
a first mirror M₁ (mirror 6) designed to orient the first beam F₁ in a direction D₁ as defined in the invention,
a second mirror M₂ (mirror 6′) designed to orient the second beam F₂ in a direction D₂ as defined in the invention,
a first window Fe₁ (window 7) situated between the chamber 3 and the mirror M₁ (window 6) and designed to cause the beam F₁ to enter the chamber 3 in a direction D₁ as defined in the invention until an impact zone P₁ coinciding with the surface S_{1′} and
a second window Fe₂ (window 7′) situated between the chamber 3 and the mirror M₂ (mirror 6′) and designed to cause the beam F₂ to enter the chamber 3 in a direction D₂ as defined in the invention up to an impact zone P₂ coinciding with the surface S₂.
a camera 8 to monitor the morphology of the sample 5, and
an infrared thermometer 9 making it possible to measure the temperature in the system 1.

As may be seen in FIG. 1, the directions D₁ and D₂ are aligned in the opposite direction. Furthermore, the direction D₁ of the beam F₁ is perpendicular to the surface S₁ of the sample 5, while the direction D₂ of the beam F₂ is perpendicular to the surface S₂ of the sample 5.

The surfaces S₁ and S₂ are spaced apart from each other by a distance d (i.e. the thickness when the sample is a film).

The window Fe₁ (window 7) preferably consists of ZnSe and has a transmission greater than about 99.5% at the wavelength of the beam F₁.

The window Fe₂ (window 7′) preferably consists of ZnSe and has a transmission greater than about 99.5% at the wavelength of the beam F₂. The mirror M₁ (mirror 6) is preferably copper coated with a gold layer and has a reflectivity greater than about 99% at the wavelength of the beam F₁.

The mirror M₂ (mirror 6′) is preferably copper coated with a gold layer and has a reflectivity greater than about 99% at the wavelength of the beam F₂.

### Example 1

A polyacrylonitrile fiber film was prepared according to the procedure as described in Zhang et al. [Advanced Energy Materials, 2016, 6, 1, 1501588, 1-9] by electrospinning from polyacrylonitrile. The resulting polyacrylonitrile fiber film had a thickness of about 100 μm.

The polyacrylonitrile fiber film obtained was heated at a temperature of about 250° C. in air [thermal stabilization substep a), then heated to a temperature of 1250° C. under argon [sub-step b) of carbonization]. The sub-step b) makes it possible to remove at least part of the heteroatoms present in the film obtained after the preceding substep a), and to avoid or limit the generation of gas during the next step i). The film obtained at the end of the sub-step b) had a predominantly disordered structure.

The surfaces S₁ and S₂ of the film obtained at the end of the sub-step b) were irradiated simultaneously using laser beams F₁ and F₂, respectively in the directions D₁ and D₂ as defined in the invention for 2 minutes at a power of 43 W, which corresponds to a power density of 85 W/cm².

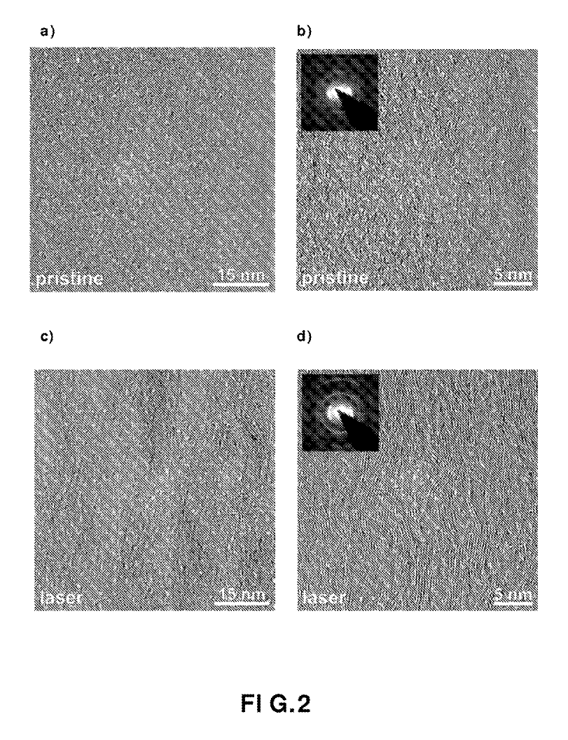

FIG. 2 shows a transmission electron microscopic (TEM) image of the non-conforming carbon fibers of the invention obtained at the end of substep (b) [FIG. 2a: 15 nm scale and FIG. 2b: 5 nm scale] and the carbonaceous material according to the invention obtained at the end of step i) [FIG. 2c: 15 nm scale and FIG. 2d: 5 nm scale]. In the carbonaceous material obtained by the method of the invention, the graphitic domains in the fibers are oriented in such a way that the graphitic layers stretch mainly along the axis of the fiber. This is demonstrated on the electron diffraction profile of the carbonaceous material (see image at top left of FIG. 2d) in comparison with the electron diffraction profile of the carbon fibers obtained at the end of substep (b) (see image at the top left of FIG. 2b).

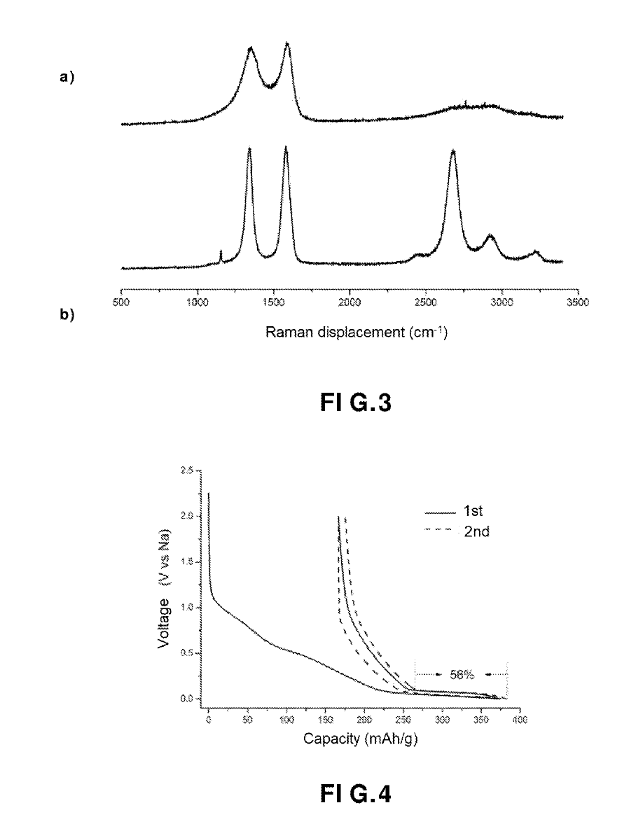

FIG. 3 shows a Raman spectrum of the carbon fibers obtained at the end of the sub-step b) [FIG. 3a] and of the carbonaceous material obtained at the end of step i) [FIG. 3b]. FIG. 3b shows a band G′ (2D) at approximately 2700 cm⁻¹ corresponding to the breathing method of the polyaromatic layers (second order of the D band). The net increase of this band after step i) shows an aromatization and growth of graphitic domains in agreement with the previous observations by TEM.

The bands G and D are characteristic bands of a carbonaceous material sp². The G (graphitic) band (1580 cm⁻¹) refers to vibration modes of graphitic structures, while the D (defect) band (1350 cm⁻¹) is characteristic of disordered graphitic structures.

Electrochemical tests were carried out in an electrochemical cell comprising metallic sodium as a counter-electrode, the carbonaceous material as obtained at the end of stage i) as a working electrode, an electrolyte solution containing sodium perchlorate as the sodium salt, and a mixture of ethylene carbonate (EC) and dimethyl carbonate (DMC) with a volume ratio of 1:1, and a glass fiber separator.

By way of comparison, a cell comprising the carbon fibers from sub-step b) as a working electrode instead of the carbon material was used.

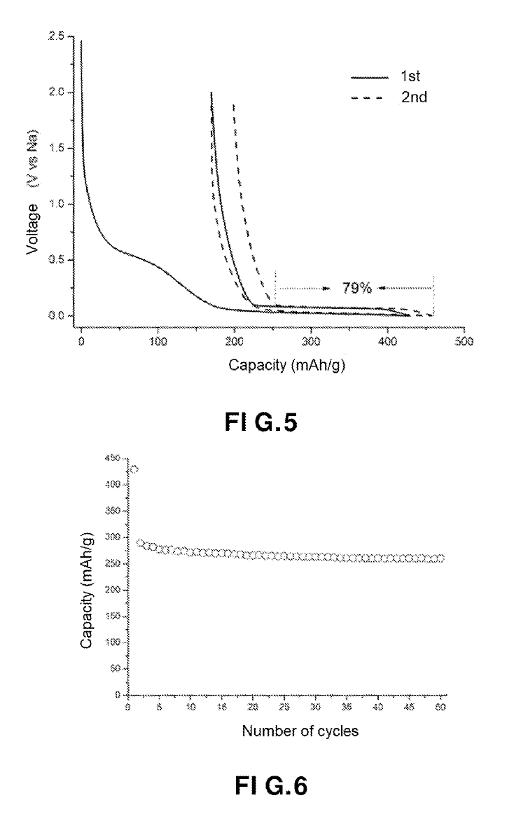

FIG. 4 shows a galvanostatic charge-discharge curve during the first two cycles of the carbon fibers from sub-step b), while FIG. 5 shows a galvanostatic charge-discharge curve during the first two cycles of the carbonaceous material derived from step i) (voltage in volts as a function of the capacity in mAh/g). These curves make it possible to test the insertion of sodium in the carbon material vs in the carbon fibers.

FIG. 6 represents the specific capacity of the carbonaceous material resulting from step i) (in mAh/g) as a function of the number of cycles.

From FIG. 4, it may be seen that the galvanostatic cycling curve of the carbon fibers obtained at the end of the sub-step b) comprises two regions: a first region consisting of a slope between 0.1 and about 1.0 V, and a second region consisting of a plateau at about 0.1 V giving a cumulative capacity of 207 mAh/g. The contribution of the second region to the overall capacity is about 56%.

After step i), FIG. 5 shows a galvanostatic cycling curve in which the first region consisting of a slope of between about 0.1 and 1.0 V decreases, induced by the increase of the graphitic domains. This first region corresponds to the insertion of sodium in disordered graphene layers. Step i) also increases the amount of nanopores between the different graphitic domains, inducing the increase of the second region consisting of a plateau at about 0.1 V. This gives a cumulative capacity of 289 mAh/g, while the contribution of the second region to the overall capacity is approximately 79%. The carbonaceous material comprises a small amount of disordered graphene layers, corresponding to the proportion of 21% of the first region.

FIG. 6 shows a good resistance to cycling of the carbonaceous material obtained according to the method of the invention. In fact, the capacity remains high of the order of 260 mAh/g for at least 50 charge-discharge cycles.

### Example 2

Example 1 was similarly reproduced with the exception of the use of a temperature of 950° C. in sub-step b) and a power of 40 W in step i).

A transmission electron microscopy (TEM) image of the carbon fibers obtained at the end of substep (b) showed a greater presence of disordered structures.

Electrochemical tests were carried out in an electrochemical cell comprising metallic sodium with a counter-electrode, the carbonaceous material as obtained at the end of stage i) as a working electrode, an electrolyte solution containing sodium perchlorate as the sodium salt, and a mixture of ethylene carbonate (EC) and dimethyl carbonate (DMC) with a volume ratio of 1:1, and a glass fiber separator.

By way of comparison, a cell comprising as working electrode, the carbon fibers from sub-step b) instead of the carbonaceous material was used.

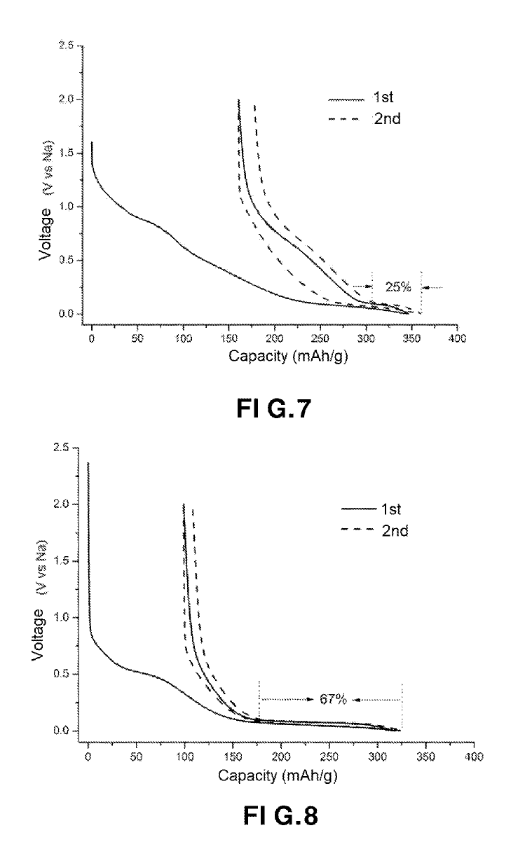

FIG. 7 shows a galvanostatic charge-discharge curve during the first two cycles of the carbon fibers from sub-step b), while FIG. 8 shows a galvanostatic charge-discharge curve during the first two cycles of the carbonaceous material derived from step i) (voltage in volts according to the capacity in mAh/g).

From FIG. 7, it can be seen that the galvanostatic cycling curve of the carbon fibers obtained at the end of the sub-step b) comprises two regions: a first region consisting of a slope between about 0.1 and 1.0 V, and a second region consisting of a plateau at about 0.1 V, giving a cumulative capacity of 181 mAh/g. The contribution of the second region to the overall capacity is about 25%.

After step i), FIG. 8 shows a galvanostatic cycling curve in which the first region consisting of a slope of between about 0.1 and 1.0 V decreases, induced by the increase of the graphitic domains. This first region corresponds to the insertion of sodium in disordered graphene layers. Step i) also increases the amount of nanopores between the different graphitic domains, inducing the increase of the second region consisting of a plateau at about 0.1 V. This gives a cumulative capacity of 216 mAh/g and the contribution of the second region to the overall capacity is about 67%. The carbonaceous material comprises a small amount of disordered graphene layers, corresponding to the proportion of 33% of the first region.

1. A method for the preparation of a solid carbonaceous material locally graphitized, comprising laser irradiation of a self-supporting solid hard carbon comprising at least two surfaces S₁ and S₂ spaced apart from one another, wherein:
the self-supporting solid hard carbon comprises at least 80 mol % of carbon and at most 20 mol % of one or more elements chosen from among hydrogen and hetero atoms,
said laser irradiation is carried out simultaneously by irradiating the surfaces S₁ and S₂ of the self-supporting solid hard carbon,
a first laser beam F₁ irradiates the surface S₁ in a direction D₁, while a second laser beam F₂ irradiates the surface S₂ in a direction D₂ opposite to the direction D₁,
the directions D₁ and D₂ of the beams F₁ and F₂ are substantially aligned, and
each of the laser beams F₁ and F₂ operates at a wavelength ranging from 0.8 μm to 15 μm and delivers a power density sufficient to graphite locally the self-supporting solid hard carbon.

2. The method according to claim 1, wherein the self-supporting solid hard carbon used in said laser irradiation comprises at least 90 mol % of carbon and at most 10 mol % of one or more elements chosen from among hydrogen and heteroatom, wherein the heteroatom is oxygen, and/or nitrogen.

3. The method according to claim 1, wherein said laser irradiation lasts from 10 seconds to 10 min.

4. The method according to claim 1, wherein said laser irradiation is carried out at a pressure of less than 10⁻⁴ mbar or at atmospheric pressure under a stream of ultra pure neutral gas comprising a quantity of oxygen <0.1 ppm.

5. The method according to claim 1, wherein said laser irradiation is performed by moving the self-supporting solid hard carbon along an axis substantially perpendicular to the directions D₁ and D₂ of the laser beams F₁ and F₂, at a speed of displacement ranging from 0.01 to 10 mm.s⁻¹.

6. The method according to claim 1, wherein the power density of the two laser beams F₁ and F₂ is identical.

7. The method according to claim 1, wherein said laser irradiation is carried out using a laser system comprising at least one laser, a chamber under vacuum or at atmospheric pressure under a stream of ultra pure neutral gas comprising an amount of oxygen <0.1 ppm, and wherein the chamber comprises a sample holder that is designed to receive the self-supporting solid hard carbon, and optical means that are designed to direct the beam F₁ in the direction D₁, and the beam F₂ in the direction D₂.

8. The method according to claim 7, wherein the laser is a carbon dioxide laser or a solid laser based on neodymium or ytterbium ion emitting in the infrared.

9. The method according to claim 7, wherein the power density of the laser varies from 50 to 150 W/cm².

10. Method according to claim 7, wherein the laser system comprises two carbon dioxide lasers.

11. The method according to claim 7, wherein the laser system comprises:
a first carbon dioxide laser configured to deliver the first beam F₁ in an initial direction D_{1′},
a second carbon dioxide laser configured to deliver the second beam F₂ in an initial direction D_{2′},
the chamber under vacuum,
a first mirror M₁ designed to orient the first beam F₁ in the direction D₁,
a second mirror M₂ designed to orient the second beam F₂ in the direction D₂,
a first window Fe₁ located between the chamber and the mirror M₁ and designed to cause the beam F₁ to enter the chamber in the direction D₁ to an impact zone P₁ coinciding with the surface S₁, and
a second window Fez located between the chamber and the mirror M₂ and designed to cause the beam F₂ to enter the chamber in the direction D₂ to an impact zone P₂ coinciding with the surface S₂.

12. The method according to claim 1, wherein the direction D₁ of the beam F₁ is perpendicular to the surface S₁ of the solid hard carbon, while the direction D₂ of the beam F₂ is perpendicular to the surface S₂.

13. The method according to claim 1, wherein the surfaces S₁ and S₂ are planar and parallel to each other.

14. The method according to claim 1, wherein the self-supporting solid hard carbon is in the form of a film or a layer, wherein the film or the layer has a thickness ranging from 20 to 200 μm.

15. The method according to claim 1 further comprising a step prior to said laser irradiation during which the self-supporting solid hard carbon is prepared from at least one organic precursor that is not graphitable, according to the following substeps:
optionally heating at least one non-graphitizable organic precursor in air at a temperature ranging from 150 to 350° C.; and
heating the product from said optionally heating or at least one non-graphitizable organic precursor under an inert atmosphere at a temperature ranging from 800 to 1500° C.

16. The method according to claim 15, wherein the non-graphitizable organic precursor is selected from the polyacrylonitrile fibers.
